(19) United States
(12) Patent Application Publication
(10) Pub. No.: US 2024/0286513 A1
(43) Pub. Date: Aug. 29, 2024

(54) ELECTRICAL SUPPLY CABLE FOR A VEHICLE

(71) Applicant: Robert Bosch GmbH, Stuttgart (DE)

(72) Inventor: Arndt Christian DUERR, Fellbach (DE)

(21) Appl. No.: 18/571,447

(22) PCT Filed: Jun. 13, 2022
(86) PCT No.: PCT/EP2022/065950

§ 371 Date: Dec. 18, 2023

(30) Foreign Application Priority Data
Jun. 25, 2021 (DE) 10 2021 206 601.1

(51) Int. Cl. B60L 53/62; B60L 53/16; B60L 53/18

(52) U.S. Cl. CPC B60L 53/62; B60L 53/16; B60L 53/18; B60L 2250/00

(57) ABSTRACT

A supply cable for electrically connecting an energy store of a vehicle to an energy supply device providing electrical energy. The supply cable includes a connecting line; a primary connector, which electrically coupled/couplable to the connecting line and has a vehicle connection for detachably electrically connecting to the energy store; a secondary connector, which is electrically coupled/couplable to the connecting line and is provided for detachably electrically connecting to the energy supply device. The supply cable has a detection apparatus configured to monitor the electrical current supplied by the energy supply device and detect an interruption of the supplied electrical current, and a limiting unit designed to limit an electrical current flowing through the supply cable to a maximum value. The detection apparatus is designed to transfer a limit value based on a current supplied prior to the detection of the interruption.

### FIELD

The present invention relates to a supply cable for electrically connecting a vehicle, in particular an energy store of a vehicle, to an energy supply device. The supply cable can, for example, be a charging cable (even if it can also be used or is configured for discharging processes from the vehicle), which is designed to transfer powers of at least 0.5 kW, preferably of at least 2 kW electrical power.

### BACKGROUND INFORMATION

Various approaches are available from the related art for electrically charging electric vehicles or hybrid vehicles (e.g., cars, trucks, boats, aircraft, two-wheelers, etc.). In particular, the following case groups can be distinguished: charging of the vehicle can take place in a first charging situation via a dedicated charging infrastructure, wherein the charging stations are in particular fixedly installed charging stations. For example, such charging stations are realized as a charging column or wall box. In an alternative charging situation, a continuous current socket is provided, as is used, for example, in normal households for energy supply. For example, this is a 220 V Schuko socket or a socket designed according to other regional standards or customs, wherein a three-phase current connection can also be provided. In this case, the charging cable generally has an integrated controller, which can, for example, be designed as an in-cable control box, ICCB, in the connecting line between the two connectors of the charging cable. This integrated controller serves to communicate with the vehicle and to release and set a charging current since, in contrast to a charging column or a wall box, a Schuko socket generally does not have a communication line via which the vehicle can communicate with the energy supply device.

If a household socket is used for charging the electric vehicle or the hybrid vehicle, a charging current is usually limited to a maximum value that is below a maximum value at which the household socket is usually fused. In a fusing of 16 A, which is, for example, customary in Germany, the integrated controller of the charging cable is generally set in such a way that a maximum current consumption of 13 A is made possible.

A secondary connector and charging cable are described in German Patent Application No. DE 10 2021 203 362 A1.

### SUMMARY

A charging cable according to the present invention allows a line network leading to a charging point, e.g., a household socket, to not be overloaded by the charging current. In particular, it is prevented that a fuse that fuses the charging connection is repeatedly tripped.

In other words, the supply cable serves to remove electrical energy from an energy supply device. If this energy supply device is fused at a lower value than a maximally removable current set in the supply cable, or if further consumers are already connected to the energy supply device or are connected after the start of the charging process, the removal of a charging current via the supply cable can, for example, lead to the fuse being tripped. According to the present invention, it is provided that the supply cable recognizes such a situation (i.e., an unplanned, undesired interruption of the current flow with respect to the charging process) in order to subsequently either automatically avoid re-tripping of the fuse or to allow a user to configure the charging cable accordingly in order to avoid future trippings of the fuse.

According to an example embodiment of the present invention, the supply cable for electrically connecting a vehicle, in particular an energy store of a vehicle, to an energy supply device providing electrical energy has a connecting line and a primary connector, which is or can be electrically coupled to the connecting line. The vehicle and the energy supply device are different components. The primary connector has a vehicle connection designed for detachably electrically connecting to the vehicle, in particular the energy store of the vehicle. The primary connector can, for example, be a type 2 plug or another plug type designed for connecting to the vehicle. Furthermore, the supply cable has a secondary connector, which is or can be electrically coupled to the connecting line and is provided for detachably electrically connecting to the energy supply device.

The primary connector and/or the secondary connector can be detachably or fixedly coupled to the connecting line. The secondary connector in particular serves to electrically connect to a continuous current socket or a household socket. For example, the secondary connector is a Schuko plug or a three-phase plug. However, it may also be a type 2 plug. The primary connector and/or the secondary connector can also (colloquially) be referred to as charging plugs.

According to an example embodiment of the present invention, the supply cable has a detection apparatus, which is configured to monitor the electrical current supplied by the energy supply device. In addition, the detection apparatus is designed to detect or ascertain an interruption of the supplied electrical current. The detection apparatus can be formed in any component of the supply cable, in particular in the primary connector or secondary connector or the connecting line or supply line. If an ICCB is present, the detection apparatus may also be formed in this ICCB. The detection apparatus can, for example, have a current sensor, e.g., a Hall sensor or the like, or be connected to such a current sensor in order to ascertain or sense or measure the electrical current flowing in the supply cable.

According to an example embodiment of the present invention, the supply cable furthermore has a limiting unit. The limiting unit serves to limit an electrical current flowing through the supply cable to a maximum value. It is designed for limiting or is configured for this purpose. The limiting unit is thus in particular provided in order to specify, as protection of the energy supply device against overloading, a maximum value for the current flowing through the secondary connector and/or through the supply cable. The flowing current can be limited to the maximum value either actively, for example by a circuit of the limiting unit that does not allow the flowing current to increase above a maximum value. The flowing current to the maximum value can alternatively or additionally be limited (indirectly or passively) by transferring the maximum value to the vehicle and/or to a charging controller of the supply cable and/or to a charging control logic of the energy supply device, so that no current that exceeds the maximum value is requested by the vehicle or supplied by the energy supply device. The limiting unit can be formed in any component of the supply cable, in particular in the primary connector or secondary connector or the connecting line. If an ICCB is present, the limiting unit may also be formed in this ICCB.

Furthermore, it is provided that the detection apparatus is configured to transfer a limit value, based on a current supplied prior to the detection of the interruption, as the maximum value to the limiting unit and/or to output it as a signal value. The limit value or the signal value can, for example, be output as a proposal for setting as the maximum value.

In other words, the detection apparatus serves to ascertain an interruption of the current supplied by the energy supply device. If such an interruption is recognized, in particular unexpectedly and/or abruptly, i.e., not at the end of a charging process, this can, for example, be attributed to the tripping of a fuse of the energy supply device. The limit value ascertained by the detection apparatus is thus such a value of the current that remains below a current tripping the interruption, since the limit value is based on a current supplied prior to the interruption. In other words, the limit value can, for example, be ascertained or determined or calculated as a function of a current supplied or sensed or ascertained prior to the interruption. It can in particular be the current that flowed through the charging cable prior to the interruption. This limit value can either be transferred or transmitted or sent directly to the limiting unit so that the latter adopts the limit value as the maximum value. Alternatively or additionally, said limit value can also be output or provided as a signal value, in particular as a proposal for setting as the maximum value. The output or provided maximum value or the signal value, which can represent the limit value, can, for example, be output to a user or to a control device or the like. The output or provided maximum value or the signal value can thereby serve, for example, as a proposal for setting or for inputting as the maximum value, for example by a user or by a control device. The maximum value set or transferred to the limiting unit or provided or output in this way thus makes it possible to reduce a risk of a further tripping of the fuse of the energy supply device. This is because the current maximally flowing through the supply cable thus is or can be limited to a value at which no tripping of the fuse previously took place. On the other hand, the present invention makes it possible to allow the greatest possible current to flow through the supply cable, since the maximum value is ascertained on the basis of the limit value and thus does not have to be estimated, possibly incorrectly, by a user. As a result, even after the fuse has been tripped, it is advantageously simultaneously possible to maintain the safety of the current branch and to minimize the charging time.

Preferred developments of the present invention are disclosed herein.

The detection apparatus is advantageously designed to detect the interruption if the supplied electrical current is reduced by more than 90% in a time interval of less than 1 s. Advantageously, the interruption is detected by the detection apparatus if the supplied electrical current is reduced by more than 90% in a time interval of less than 100 ms. Alternatively or additionally, it can, for example, be provided that an interruption is detected or a situation is classified or recognized as an interruption if a comparison of the ascertained reduction in the electrical current with a planned reduction in the electrical current exceeds a limit value. Thus, a target value of the current can, for example, be present or provided or read at any point in time or at defined points in time from the charging controller of the supply cable, of the vehicle, and/or of the energy supply unit (for example by the supply cable or by the detection apparatus or detection unit). Furthermore, an actual value of the current can be sensed or provided at different points in time. A comparison of the actual value and the target value (e.g., a difference formation) can indicate an interruption or be evaluated or recognized as an interruption of the current if this comparison, for example, exceeds a threshold value. Such a threshold value can, for example, be formed in that the difference between the target value and the actual value increases to more than 90% of the target value within one second or within 100 ms. As a result of such an abrupt drop in the electrical current, it is, for example, possible to deduce a tripping of the fuse of the energy supply device. The current flowing through the supply cable can, in particular, also decrease when a charging process is terminated, for example by the vehicle. In this case, it can however happen that no correspondingly abrupt drop in the electrical current is present so that the interruption can be reliably detected on the basis of the criteria described above.

Or a signal that the current is reduced or interrupted can be transmitted to the supply cable or the detection apparatus or the detection unit, as described above, by the vehicle or an ICCB or a charging control logic of the energy supply device. In this case, by comparing the current to be expected with the current ascertained during the monitoring, it can be determined whether a conspicuous difference is, for example, present in a comparison between the target value and the actual value. If such a conspicuous difference is present in the comparison, this can be understood as an unexpected interruption which, for example, indicates a tripping of the fuse.

As a result of the described interruption recognition, it can advantageously be reliably recognized that an overload has occurred, and this can be used for a subsequent charging process or for informing the user.

According to an example embodiment of the present invention, it is preferably provided that the detection apparatus is designed to ascertain the limit value as a function of the last current value detected prior to the interruption. Alternatively, it is provided that the detection apparatus or detection unit is designed to ascertain the limit value as a function of the mean value of a plurality of detected current values in a predefined time window prior to the interruption (e.g., within the last 100 ms prior to the interruption). As a further alternative, it is provided that the detection apparatus is designed to ascertain the limit value by applying a filtering to a plurality of detected current values prior to the interruption.

Alternatively, according to an example embodiment of the present invention, the limit value can also be ascertained by forming a time derivative of the current and assuming the interruption event when a limit value of the derivative is exceeded. One or more of the current values prior to the limit value can then be used for determining the (new) maximum value or the limit value.

Alternatively or additionally, according to an example embodiment of the present invention, it may be provided to ascertain the interruption by the following steps: (a) reading or ascertaining a target value for the current, (b) reading or ascertaining an actual value for the current, (c) comparing the target value and the actual value, for example by a difference formation or the like, (d) deciding whether an interruption is present, as a function of the comparison, for example if a difference value of the target value and the actual value exceeds a threshold value.

All these alternatives can advantageously also be combined. The detection apparatus is in particular designed to additionally take into account a safety margin for the (new) maximum value or limit value. The safety margin is in particular at least 5% of the ascertained limit value (i.e., of the current flowing prior to the interruption), preferably at least 10% (e.g., if 10 A is ascertained as an interruption current value, the new limit value is 9.5 A with a 5% safety margin, 9.0 A with a 10% safety margin). Alternatively or additionally, said safety margin is advantageously at least 0.5 A, particularly advantageously at least 1.0 A, e.g., exactly 0.5 A or exactly 1.0 A. If the limit value is ascertained, as described above, as a function of the last current value detected prior to the interruption, it is in particular provided that the detection apparatus ascertains the interruption as an event during which the flowing current drops.

The measured values of the flowing current that have been ascertained in terms of time prior to said drop in the current are in particular values that can be accepted as the limit value, advantageously with said safety margin. The last current value detected prior to the interruption is thus in particular a current value from which a drop in the current was ascertained.

If the detection apparatus determines, for example, that a current current value is considerably lower than a previously ascertained current value, an interruption is present and the previously ascertained current value is the last current value detected prior to the interruption. If a mean value of a plurality of detected current values prior to the interruption is used to ascertain the limit value, the mean value can be a weighted or unweighted mean value. In particular, measured current values that are closer in time to the interruption can in particular be weighted higher than measured current values that have a greater time distance from the interruption. The predefined time window prior to the interruption can, merely by way of example, be designed in such a way that it has a time period of at most 2 s. Alternatively, the time window can, for example, have a duration of at most 1 s. It can, for example, also be advantageously provided that the time window lasts at most 500 ms, in particular 200 ms. If the current value is ascertained at a sampling time of 50 ms, at least 4 current values can, for example, be taken into account in ascertaining the mean value, alternatively 10 measurement values or 20 measurement values or 40 measurement values. The previously described safety margin makes it possible for the limit value to be below the tripping threshold of the fuse, even when taking into account tripping tolerances of a fuse of the energy supply device. When the limit value ascertained in this way is used, the risk of re-tripping the fuse of the energy supply device is thus minimized since the current flowing through the supply cable remains below a value that has already previously not led to a tripping of said fuse of the energy supply device.

The limit value can also be similarly or analogously ascertained if a method as described above is used using target values and actual values; in this case, that actual value, for which the comparison has just undershot the threshold value or a further threshold value, can then, for example, be used as the limit value. If, for example, the interruption threshold value is 90% of the target value, the further threshold value can, for example, be 10% of the target value. If the interruption threshold value is thus reached, an interruption is present. The temporally last value prior to the interruption criterion (or a mean value of values or the like, see the above statements) can then, for example, be used as the limit value, or else a last value prior to the interruption for which the difference value was lower than the further threshold value, i.e., in the example lower than 10%.

In a preferred example embodiment of the present invention, it is also provided that the supply cable can be switched between a learning mode and a normal mode. The limiting unit is designed to gradually increase the current flowing through the supply cable, according to a predefined rule up to the set maximum value in learning mode. In normal mode, the limiting unit is designed to limit the current flowing through the supply cable to the maximum value. A difference between the learning mode and the normal mode is in particular such that, in learning mode, the limiting unit does not directly enable a current up to the maximum value (as in normal mode, in which, as it were, “a switch is thrown”), but an increase in the current up to the maximum value is delayed or stretched over a predefined time period. In this way, an interruption of the current can in particular be reliably recognized, wherein it can be recognized in an improved manner at which current value the interruption takes place. The limit value can thus be ascertained more accurately.

Alternatively or additionally, according to an example embodiment of the present invention, the supply cable is designed to carry out monitoring of the electrical current supplied by the energy supply device, at a higher monitoring rate in learning mode than in normal mode. This additionally enables improved and more accurate ascertainment of the interruption of the current in order to be able to thus ascertain the limit value more accurately. If, for example, it is provided that a current value is ascertained or read from a sensor every 50 ms in normal mode, it is, for example, provided in learning mode that a measurement value is ascertained or read from said current sensor every 10 ms or every millisecond. The limit value can thus be ascertained safely and reliably as a result of the learning mode. If, in learning mode, an interruption of the current takes place during the increase of the current up to the maximum value, the probability of a further interruption when the supply cable is again used at the energy supply device is minimized since the limiting unit and the detection apparatus have reached the boundary conditions for the greatest possible accuracy of ascertaining the limit value.

If no interruption takes place during the learning mode, the flowing current can at most assume the maximum value, as a result of which no further influences on the charging process are performed with the exception of the delay of the increase in the current up to the maximum value. The learning mode is, in particular, advantageous in a first use of the supply cable at an unknown energy supply device in order to test a fuse of the energy supply device. Particularly advantageously, the learning mode can be applied several times in succession if an interruption was detected in learning mode. In this case, the previously ascertained limit value can be used as the maximum value for a new run of the learning mode. A tripping threshold of a fuse of the energy supply device can thus be ascertained accurately and reliably. Ideally, a fuse trips at most a single time if no additional consumers are connected.

According to an example embodiment of the present invention, the predefined rule is advantageously a predefined ramp for increasing the current. The predefined ramp starts from a predefined starting value, which can, for example, be 0 A or 1 A or 2 A. Starting from this predefined starting value, the ramp allows an increase in the current by means of a predefined gradient, e.g., 1 A/s or 0.5 A/s or 0.1 A/s. The predefined ramp can, in particular, also be designed in multiple stages and comprise different gradients, e.g., a first range with a first gradient and a second range with a second gradient, wherein the second gradient enables a flatter increase in the current (e.g., first gradient: 1 A/s to 2 A or to 4 A below the maximum value, second gradient: 0.1 A/s up to the maximum value). The current flowing through the supply cable is thus first increased with the first gradient, subsequently with the second gradient until the maximum value is reached. Since a risk of an interruption of the current increases with increasing current intensity, better monitoring in the range of said maximum value is thus made possible. The predefined ramp can, in particular, also be designed in such a way that it starts from a predefined starting point selected as a function of the maximum value. Thus, said ramp can, for example, comprise a range of 80% below the maximum value up to the maximum value or 50% below the maximum value up to the maximum value. In any case, the ramp achieves that an increase in the current cannot take place abruptly, which would make detection of the limit value more difficult. By using the ramp, the limit value can be ascertained much more simply and reliably, in particular also accurately.

According to an example embodiment of the present invention, the supply cable advantageously has a location sensor in order to ascertain and/or store a link between the limit value and a location at which the limit value was ascertained. Merely for example, the detection apparatus or detection unit can have the location sensor. The supply cable or the detection apparatus is particularly advantageously designed, when a location at which a limit value is stored linked is reached, to transfer the limit value linked to the location as the maximum value to the limiting unit and/or to output it as a signal value. The signal value or the limit value can, for example, be output as a proposal for setting as the maximum value, in particular to a user. In particular, it is thus made possible to use maximum values that have already been ascertained or input. Recurring charging situations can thus be advantageously represented since the risk of re-tripping the fuse of the energy supply device is reduced. Thus, on the one hand, a user does not have to constantly perform a reconfiguration of the supply cable if the user repeatedly charges their vehicle at the same energy supply device. At the same time, it is in particular avoided that the limit value must be repeatedly re-ascertained as a result of repeated learning processes and the associated risk of tripping the fuse of the energy supply device. The comfort in the use of the supply cable is thus improved.

The location sensor can, for example, be designed as a GPS sensor. However, it can also be a sensor or a device that, for example, performs an (absolute) location determination on the basis of WLAN signals or MAC addresses or a radio cell assignment in mobile radio networks. Other sensors, which enable a (relative) assignment to a location, are also possible. This can, for example, be an RFID reader that can read an RFID chip at a socket and can thereby at least indirectly ascertain a location since sockets are generally not mobile.

According to an example embodiment of the present invention, the limiting unit is advantageously designed to output or send the maximum value to the vehicle and/or to a charging control logic of the supply cable or of the energy supply device. In particular, the limiting unit is designed to notify the vehicle that the maximum value output or sent or transferred can at most be requested as the charging current. The current flowing through the supply cable can thus be simply and reliably limited by the limiting unit. For this purpose, the limiting unit merely communicates the maximum value to the vehicle and/or the charging control logic, as a result of which the vehicle and charging control logic start a charging process during which the maximum value is not exceeded. Transferring the maximum value to the vehicle and/or the charging control logic can, for example, take place via a communication line provided for communication between the vehicle and the charging control logic. Alternatively or additionally, the maximum value can be transferred in such a way that the supply cable has a variable current-carrying capacity coding that can be read by the vehicle and/or the charging control logic. This current-carrying capacity coding can in particular be used to limit the charging current flowing through the supply cable. Alternatively or additionally, the maximum value can also be transmitted or output or sent wirelessly.

In this way, it is advantageously brought about that the limiting unit can be designed to be particularly compact, since an electrical or electronic (active) current limitation or a circuit configured for this purpose must not necessarily be provided. As a result, the secondary connector can be constructed to be simpler, more cost-effective and more space-saving or more compact and more lightweight.

According to an example embodiment of the present invention, the supply cable advantageously has an output unit. The output unit is in particular configured to output a signal, in particular an acoustic or visual warning, when the detection apparatus detects the interruption.

As a result, the user can advantageously recognize that the set maximum value was possibly too high and can respond thereto by a reduction in the maximum value in order to thus prevent repeated interruption of the charging process and/or permanent overloading of the current branch.

Alternatively or additionally, according to an example embodiment of the present invention, the output unit is designed to output a signal that the maximum value set by the limiting unit is lower than a maximally possible maximum value. The maximally possible maximum value is, in particular, a technically maximally possible current that can flow through the supply cable without damaging it or violating any other specifications of the supply cable.

The user can thereby advantageously recognize that a charging process can last longer than would be possible in the best case utilizing the maximally possible maximum value. In this way, it can advantageously be prevented that, after previously charging at only a low maximum value at a location, the user maintains this low maximum value by mistake, even though a significantly higher current consumption would be possible at the next charging location.

According to an example embodiment of the present invention, the signal output by the output unit can, in particular, also be transferred to a user terminal, such as in particular a smartphone, in order to indicate corresponding warnings and/or information to the user of the supply cable on the user terminal.

The output unit can, for example, be arranged in or on the primary connector, which advantageously makes it directly operable for the user in the vicinity of the vehicle. Alternatively or additionally, the output unit can, for example, be arranged in or on the secondary connector, as a result of which the signals for a specific energy supply device can advantageously be made accessible to the user. Alternatively or additionally, the output unit can, for example, be arranged in or on the connecting line and/or in a possibly present ICCB in the connecting line, as a result of which, advantageously, the output unit can be extended over a larger area and the placement is more flexible.

In a development of the present invention, the supply cable advantageously has a setting apparatus. The maximum value can be (flexibly) set via the setting apparatus, in particular by a user. The setting apparatus preferably has a rotary knob or a slider or a touchscreen or a keypad for inputting the maximum value. In this way, the user themselves can specify the maximum value. The detection apparatus is advantageously designed to preset the limit value as the maximum value, for example by means of an actuator actuating the rotary knob or the slider. Likewise, the limit value can be set as a proposal for input via the keypad. In a further embodiment, it is provided that the supply cable has a display on which the limit value is displayed as a proposal in order to aid the user in setting the maximum value via the setting apparatus. By means of the setting apparatus, a simple, operable limitation of the maximum value is advantageously made possible with simple means, which limitation a user can, for example, perform at will. This advantageously increases the safety and operating comfort of the supply cable.

In a development of the present invention, the maximum value can advantageously be selected from a plurality of predefined values via the setting apparatus. The predefined values are, in particular, fixedly set current values, such as 2 A, 4 A, 6 A, 8 A, 10 A and 13 A. If the setting apparatus is, for example, designed with a rotary knob or slider as described above, the rotary knob and/or the slider can preferably have latching stages that correspond to the corresponding predefined values. When using a touchscreen, individual buttons that correspond to the stages can be displayed and, when using a keypad, individual keys can, for example, be assigned to fixed maximum values. Simple and intuitive settability of the maximum value is thus given. Alternatively or additionally, the maximum value can be steplessly set from a predefined interval via the setting apparatus. The predefined interval is, for example, the interval between 1 A and 13 A. The term “stepless” in this context in particular means that a smallest gradation that is unavoidable in digital signal processing is at most 0.2 A or at most 0.1 A.

According to an example embodiment of the present invention, the supply cable advantageously has a memory. The memory serves to store different maximum values, in particular by the user. It can be designed to store different maximum values. Thus, if the setting apparatus does not have a rotary knob or a slider as described above, predefined values can, for example, be stored, which can in particular be set simply and intuitively as the maximum value for the limiting unit. Thus, different maximum values for different energy supply devices that are used more frequently can in particular be stored and simply and cost-effectively retrieved in order to achieve rapid configuration of the supply cable. If, for example, a reasonable limitation of the current is 8 A in a first garage and 12 A in a second garage, the two maximum values can be stored in the memory and can be retrieved and/or set quickly and simply depending on the location of the charging process.

According to an example embodiment of the present invention, the supply cable preferably has a communication module. The communication module in particular serves for communication with a user terminal. It is thus provided that the maximum value can be adjusted or set via the user terminal. The communication module can, for example, be configured for wireless communication with the user terminal. The user terminal is in particular a device that is separate from the supply cable and that can, for example, communicate with the supply cable in a wireless or temporarily wired manner.

The user terminal is, for example, a smartphone. A user of the user terminal can thus advantageously configure the supply cable or set the maximum value in a particularly simple manner and also from a greater distance (e.g., via the communication module arranged, for example, in the primary and/or secondary connector and/or in the connecting line). In addition, it can, for example, be provided that the communication module be designed to send signals that contain a current currently flowing through the supply cable and/or an electrical energy flowing through the supply cable, to the user terminal. Statistics and/or billing functions for the charging process can thus, in particular, be simply and cost-effectively realized or retrieved for the user or an energy provider.

According to an example embodiment of the present invention, the supply cable preferably has a release unit, which is designed to release the settability of the maximum value via the setting apparatus. The release unit can, for example, have a locking slider and/or a mechanical or electronic lock and/or a fingerprint sensor. The release unit prevents an unintentional or undesired manipulation or adjustment of the maximum value from taking place, for example. This could, for example, happen by accidentally displacing a slider or a rotary knob. By means of a mechanical lock, the mechanical adjustability of the setting apparatus can, for example, be prevented. By means of an electronic lock, the setting or changing of the maximum value can in particular be prevented, even though mechanical access to the setting apparatus is still granted. The mechanical lock can, for example, be a locking of the rotary slider or of the rotary knob as described above. The electronic lock is advantageously a software solution which prevents newly set maximum values from being accepted as long as this input has not been released. The use of a fingerprint sensor particularly advantageously makes it possible to prevent the adjustment or setting of the maximum value unless an authorized person that is unambiguously authenticated by the fingerprint sensor performs this setting. This advantageously increases the safety of the use of the supply cable or of individual components thereof (e.g., primary/secondary connector, connecting line).

In an advantageous development of the present invention, it is provided that the supply cable has a reset function, wherein a maximally possible maximum value is set or input when the reset function is activated. The maximally possible maximum value can, for example, be a technically maximally possible maximum value, i.e., a maximum value that is specified by technical limitations. For example, it may be provided that the reset function can be activated by a user and/or is activated, in particular automatically activated, for example by mechanical and/or electrical/electronic means, when the supply cable is decoupled from the energy supply device. The reset function makes it possible for a maximally possible maximum value, for example a technically maximally possible maximum value, to be set or input. As described above, the (for example technically) maximally possible maximum value can in particular be a value that corresponds to the current-carrying capacity of the supply cable. In other words, a user can reset set lower maximum values via the reset function and can thus allow a technically maximally possible current through the supply cable. As a result, a very rapid adjustment or setting can advantageously be performed, which increases user-friendliness.

The connecting line or the supply line of the supply cable advantageously has a coupling. The coupling is designed to be detachably electrically connected to the secondary connector. Thus, different secondary connectors can in particular be attached to the supply cable. The supply cable can thus be designed, for example, to also accommodate, in addition to the above-described secondary connector, secondary connectors that enable an electrical connection to other types of energy supply devices.

The present invention also preferably relates to a secondary connector. The secondary connector can in particular be used as part of a supply cable for electrically connecting a vehicle, in particular an energy store of a vehicle, to an energy supply device providing electrical energy. The secondary connector in particular serves to electrically connect to a continuous current socket or household socket, wherein it can in principle also, for example, be configured to connect to a three-phase socket or a type 2 socket. The vehicle and the energy supply device are different components. The secondary connector has a plug connector, which is provided for detachably electrically connecting to the energy supply device. For example, the plug connector is a Schuko plug. Likewise, the plug connector can be designed to connect to a dedicated charging infrastructure, e.g., a wall box or charging column, and can in particular be a type 2 plug. In addition, the secondary connector preferably has a cable connection for releasably electrically connecting to a coupling of the supply cable. The secondary connector can, for example, also have a limiting unit. The limiting unit serves to limit an electrical current flowing through the secondary connector and/or through the supply cable to a maximum value.

The limiting unit is thus in particular provided in order to specify a maximum value for the current flowing through the secondary connector and/or through the supply cable, as protection of the energy supply device against overloading. The specification of the maximum value of the flowing current can take place either actively by a circuit of the limiting unit or by transfer of the maximum value to the vehicle and/or a charging controller of the supply cable and/or a charging controller of the energy supply device. The secondary connector can, for example, advantageously have a setting apparatus. The maximum value can be set via the setting apparatus, in particular by a user. The secondary connector thus allows setting the maximum value of the flowing current and limiting the flowing current to the maximum value. By in particular forming the setting apparatus in the secondary connector, it is on the one hand achieved that, when connecting the secondary connector, a user is reminded by looking at the setting apparatus to adjust the maximum value if necessary. For a user, the setting of the maximum value is thus linked directly to the process of electrically connecting the secondary connector and the energy supply device. This advantageously reduces the risk that the setting of the maximum value is forgotten. On the other hand, it is ensured that the limitation to the maximum value takes place only if the specially designed secondary connector is used. Thus, different secondary connectors can, for example, be attachable to supply cables. In other words, the use of another secondary connector without a setting apparatus or limiting apparatus on the supply cable is also possible if the setting possibility and/or limitation possibility is not desired or required. Inadvertently maintaining a current limitation for other charging situations is thus avoided. For example, the (limitable) secondary connector can be designed as described above for a household socket for which a (flexibly settable) current limitation is provided. In addition to the above-described secondary connector, a further secondary connector for connecting to a dedicated charging infrastructure, e.g., a type 2 plug, in which a user does, for example, not want to provide a flexibly settable current limitation, can, for example, be used on the supply cable. Thus, in this example, when changing from one secondary connector to the other secondary connector, inadvertently maintaining the current limitation is prevented since the flexible current limitation functionality is coupled or linked to the secondary connector in this example.

### BRIEF DESCRIPTION OF THE DRAWINGS

Exemplary embodiments of the present invention are described in detail below with reference to the figures.

FIG. 1 is a schematic representation of a supply cable according to an exemplary embodiment of the present invention in its intended use.

FIG. 2 is a schematic detailed view of a secondary connector of the supply cable according to the exemplary embodiment of the present invention.

FIG. 3A shows a current flow during a first operating mode of the supply cable according to the exemplary embodiment of the present invention.

FIG. 3B shows a current flow during a second operating mode of the supply cable according to the exemplary embodiment of the present invention.

FIG. 4A is a first schematic detailed view of the secondary connector of the supply cable according to the exemplary embodiment of the present invention.

FIG. 4B is a second schematic detailed view of the secondary connector of the supply cable according to the exemplary embodiment of the present invention.

FIG. 5 is a further schematic detailed view of the secondary connector of the supply cable according to the exemplary embodiment of the present invention.

### DETAILED DESCRIPTION OF EXAMPLE EMBODIMENTS

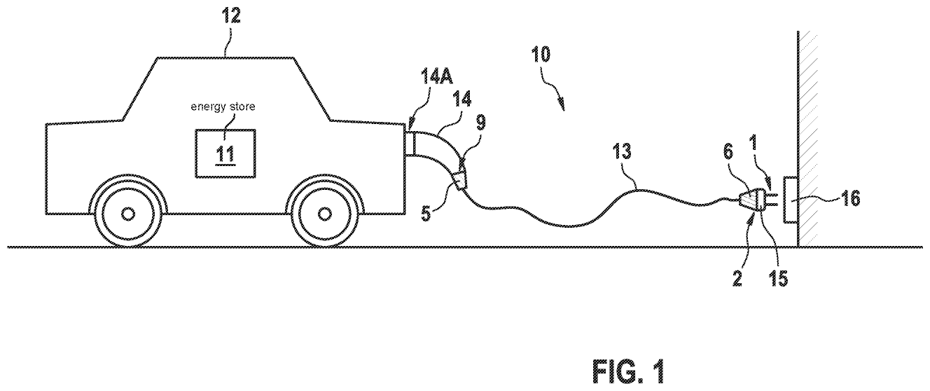

FIG. 1 schematically shows a vehicle 12 with an energy store 11 and an energy supply device 16. In this case, merely by way of example, the energy supply device 16 is designed as a household socket, e.g., as a Schuko socket. In principle, however, it can also be a type 2 socket of a wall box or of a charging column or a three-phase current connection, without being limited to one of these types. In addition, FIG. 1 shows the intended use of a supply cable 10 according to an exemplary embodiment of the present invention.

The supply cable 10 has a connecting line 13 or a supply line 13, which is electrically coupled at one end to a primary connector 14 and at another end to a secondary connector 15. The electrical coupling between the connecting line 13 or supply line 13 as well as the primary connector 14 and the secondary connector 15 can be permanently present, wherein an alternative embodiment is shown in FIG. 1. It is provided here that the primary connector 14 and the secondary connector 15 are coupled to the connecting line 13 in each case via a detachable connection. For this purpose, the connecting line 13 has a coupling 6 and an additional coupling 5, wherein the coupling 6 serves to electrically connect to the secondary connector 15.

The additional coupling 5 serves to electrically connect to the primary connector 14. For this purpose, the secondary connector 15 has a cable connection 2, which is designed for electrically connecting to the coupling 6 of the connecting line 13. The primary connector 14 has an additional cable connection 9, which is designed for electrically connecting to the additional coupling 5 of the connecting line 13.

The primary connector 14 also has a vehicle connection 14A, via which an electrical connection to the vehicle 12, in particular to the energy store 11, can be established. The secondary connector 15 has a plug connector 1, which is designed for detachably electrically connecting to the energy supply device 16. The vehicle 12, in particular the energy store 11, and the energy supply device 16 can thus be electrically connected to one another via the supply cable 10.

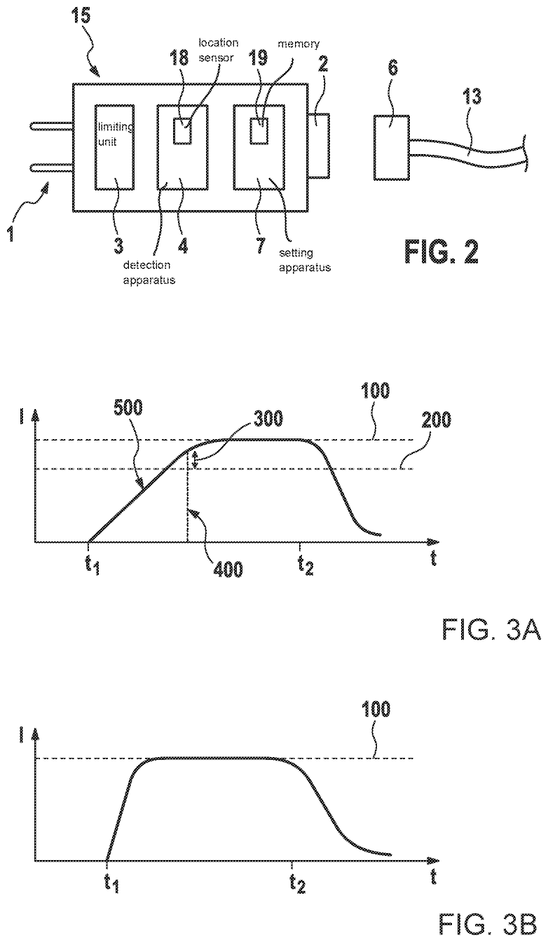

The secondary connector 15 allows or enables a current limitation function in order to, for example, recognize and/or avoid an overloading of the energy supply device 16. As shown in FIG. 2, it is advantageously provided that the supply cable 10, here, by way of example the secondary connector 15 of the supply cable 10, has a limiting unit 3, which is designed to limit a current flowing through the supply cable 10.

Advantageously, a detection apparatus 4 and/or a setting apparatus 7 are additionally provided. In the exemplary embodiment shown, the limiting unit 3, the detection apparatus 4, and the setting apparatus 7 are shown and described as part of the secondary connector 15. In alternative embodiments, the limiting unit 3 and/or the detection apparatus 4 and/or the setting apparatus 7 can also be formed in other components of the supply cable 10, such as the connecting line 13 and/or the primary connector 14 and/or, if present, an ICCB.

The detection apparatus 4 is advantageously configured to monitor the electrical current supplied by the energy supply device 16. In addition, the detection apparatus 4 is preferably configured to detect an interruption of the supplied electrical current. Details of the detection apparatus 4 are described below with reference to FIG. 3A and FIG. 3B.

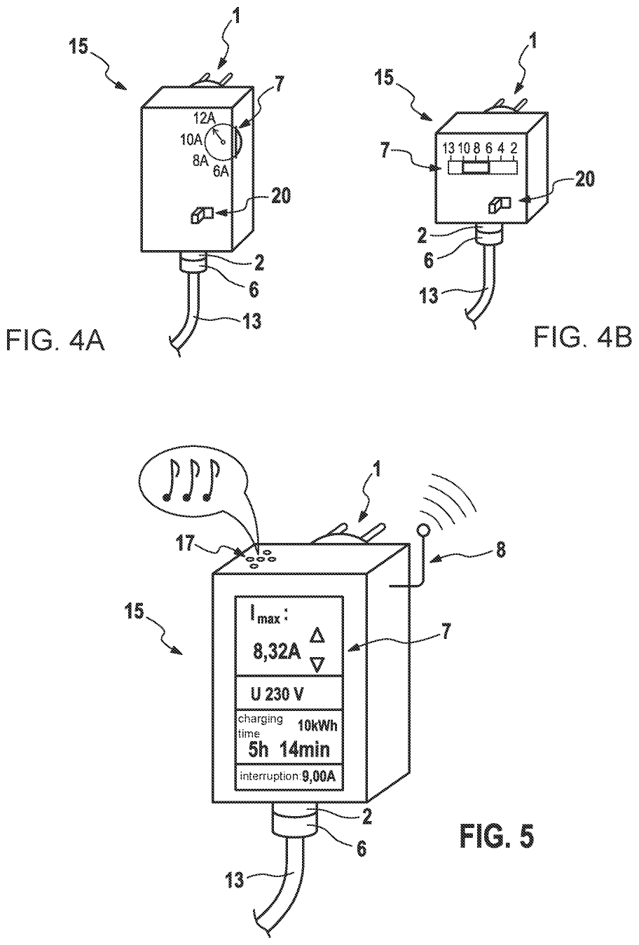

The setting apparatus 7 allows the setting of a maximum value 100, which is taken into account by the limiting unit 3. The details relating to the setting apparatus 7 are in particular shown in FIG. 4A and FIG. 4B and are described below.

The limiting unit 3 can thus receive a maximum value 100 from the detection apparatus 4 and/or the setting apparatus 7, which maximum value corresponds to a maximum current that is to flow through the supply cable 10 and/or the secondary connector 15. The limiting unit 3 can either itself perform this specification by actively influencing the flowing current or alternatively transfer the obtained maximum value 100 to a charging controller of the supply cable 10 and/or of the vehicle 12 and/or of the energy supply device 16. Such a transfer of the maximum value 100 allows the charging controller to take the specification of the maximum current into account during the charging process and to in particular set a charging current to at most said maximum value 100. If, on the other hand, the limiting unit 3 is designed to itself influence the flowing current, the limiting unit 3 limits the current autonomously and independently of the charging process, which is, for example, controlled or regulated by a separate control unit of the supply cable 10.

A transfer of the maximum value 100 to the charging controller can, merely for example, take place via a communication line, which is provided in the supply cable 10 and designed for the communication of the vehicle 12 with a control unit of the supply cable 10 and/or a charging controller of the energy supply device 16. Alternatively, a transfer can also take place wirelessly. Alternatively, it is advantageously provided that the supply cable 10 and/or the secondary connector 15 have a coding indicating a current-carrying capacity of the supply cable 10 and/or the secondary connector 15. This coding can, for example, be an electrical resistance. If the vehicle 12 and/or the energy supply device 16 recognizes said coding, the vehicle 12 and/or the energy supply device 16, on the one hand, knows that a supply cable 10 is connected. On the other hand, the current-carrying capacity with which the supply cable 10 can at most be loaded is known. By adjusting this coding by means of the limiting unit 3, the current flowing through the supply cable 10 and/or the secondary connector 15 can thus be limited. Thus, a simple and reliable transfer of the maximum value to the energy store 11 of vehicle 12 and/or the energy supply device 16 and/or a control unit of the supply cable 10 takes place.

As already described above, the detection apparatus 4 allows ascertaining an interruption of the current supplied by the energy supply device 16. FIG. 3A shows this schematically on the basis of a diagram representing the profile of the current I over the time t. FIG. 3A also shows that the supply cable 10 is in a learning mode. In learning mode, it is provided that the limiting unit 3 gradually increases the current flowing through the supply cable 10, according to a predefined rule up to the set maximum value 100. The predefined rule comprises a predefined ramp 500 for gradually increasing the flowing current. Thus, in the diagram shown in FIG. 3A, a charging process of the energy store 11 of the vehicle 12 starts at a starting time t1. However, the current requested by the vehicle 12 is released not directly up to the maximum value 100 but with a predefined gradient, e.g., 1 A/s, according to the predefined ramp 500. In contrast thereto, FIG. 3B shows a corresponding diagram for when the supply cable 10 is in a normal mode in which such a gradual increase does not take place. Rather, at the starting time t1, the flowing current is in this case released directly up to the maximum value 100.

If an interruption 400 of the current supplied by the energy supply device 16, in particular an interruption that is unexpected or unplanned by the charging control logic and/or the vehicle 12, takes place, tripping of a fuse of the energy supply device 16 or another undesired state or fault is to be assumed.

Particularly advantageously, the secondary connector 15 can additionally have a (not shown) acceleration sensor and/or rotation rate sensor and/or a force sensor (which, for example, recognizes that the secondary connector and the mating plug connector of the energy supply device 16 are plugged together) and/or another sensor on the basis of which it can be ascertained that the secondary connector 15 has not moved and thus the secondary connector 15 has not separated from the energy supply device 16 and that there is thus no interruption of the current that is to be expected. The interruption 400 is, merely by way of example, recognized by the detection apparatus 4 if the supplied electrical current is reduced by, for example, more than 90% in a time interval of less than 1 s, in particular in a time interval of less than 100 ms. Such a short-term and abrupt drop in the electrical current indicates said tripping of the fuse of the energy supply device 16 or another fault. If, on the other hand, a drop in the current takes place due to a reached charging end time t2, this drop is, as shown in FIG. 3A and FIG. 3B, not correspondingly abrupt as in the case of the interruption 400. Even if a rather abrupt interruption were to occur here, the interruption is planned, for example by the charging control logic of the vehicle 12 and/or the charging controller of the supply cable 10 and/or of the energy supply device 16. This interruption can thus be distinguished from an unplanned interruption by a comparison of the target current profile with an ascertained or sensed actual current profile, e.g., by difference formation.

A limit value 200, which is based on the current value flowing prior to the interruption 400, can be ascertained by the detection apparatus 4. Thus, the detection apparatus 4 can, for example, be designed to ascertain the limit value 200 as a function of the last current value detected prior to the interruption 400. Alternatively or additionally, the limit value 200 can be ascertained by the detection apparatus 4 as a function of a plurality of current values prior to the interruption 400, e.g., as a function of a mean value of a plurality of detected current values in a predefined time window prior to the interruption 400. Such a mean value can, for example, be weighted in such a way that current values that are closer in time to the interruption 400 experience a greater weight than current values that have a greater time distance from the interruption 400. A further alternative of ascertaining the limit value 200 by means of the detection apparatus 4 is the application of a filtering to a plurality of detected current values prior to the interruption 400. The interruption 400 can, for example, also be ascertained or determined by ascertaining a time derivative of the current profile or a time differential quotient. If the derivative (or its absolute value) exceeds a limit value, this can be evaluated as an indication of the interruption. Advantageously, a safety margin 300 is additionally taken into account, which in particular is at least 5% of the ascertained limit value 200, preferably at least 10%, or is at least 0.5 A or 1.0 A. A limit value 200 that is below the current level that has, for example, led to the tripping of the fuse of the energy supply device 16 or to the other fault is ascertained in this way. This limit value 200 can either be transferred or sent directly to the limiting unit 3 by the detection apparatus 4 so that the limiting unit 3 uses this limit value 200 as the new maximum value 100. Alternatively, the limit value 200 can be output or sent as a proposal for a maximum value 100 to be entered, for example output to a user or on a display. The user of the supply cable 10 is thus given assistance in order to specify the maximum value 100. The user in particular does not have to estimate the maximum value 100, which possibly leads to excessively low estimated values. In this case, a current lower than technically possible would be allowed, as a result of which a charging process of the energy store 11 of the vehicle 12 would unnecessarily be prolonged.

On the basis of FIG. 3A, the detection of the interruption 400 during the learning mode was described. In learning mode, it may be provided, merely by way of example, that a higher sampling of the flowing current takes place than during the normal mode. The current can in this case, for example, be sampled by a current sensor not shown here. The latter can, for example, be arranged in the secondary connector. It can, for example, be a Hall sensor, etc. If, for example, in normal mode, a current value is ascertained or sensed every 50 ms, it is provided in learning mode that, for example, a current value is ascertained every 10 ms or every millisecond. As a result of the finer sampling and as a result of the predefined ramp 500, it is thus possible to ascertain more accurately than in normal mode at which current level the interruption 400 actually took place.

Nevertheless, the detection apparatus 4 is also designed in normal mode to detect interruptions 400. In any case, the user is thus given assistance by the ascertained limit value 200, wherein this is possible more accurately in learning mode than in normal mode. In normal mode, there is instead no delay of the current increase by means of the ramp 500, which leads to faster charging of the energy store 11 of the vehicle 12. The learning mode can advantageously be used if charging is to take place for the first time at an unknown energy supply device 16. The learning mode can also be used several times in succession with updated maximum value 100 in order to achieve an approach to the tripping characteristic of the fuse of the energy supply device 16.

As shown schematically in FIG. 2, the supply cable 10, here merely by way of example the secondary connector 15, can, for example, particularly advantageously comprise a location sensor 18 (for example, for absolute coordinates, a GPS sensor or a WLAN signal module, for example for identifying MAC addresses or the like, or a sensor for sensing mobile radio data cells or, for relative or charging point-specific data, for example an RFID sensor or the like). As shown here merely by way of example, this location sensor 18 can be provided in the detection apparatus 4. However, it may also be formed separately therefrom. The location sensor 18 serves to ascertain a current location of the supply cable 10 and/or of the secondary connector 15. A link between the ascertained limit value 200 and a location at which the limit value 200 was ascertained can be established and/or stored by the location sensor 18, for example in a memory 19 of the secondary connector 15 or, in general, a component of the supply cable 10. The location at which the limit value 200 was ascertained thus corresponds to the location of the energy supply device 16. The energy supply device 16 can thus be characterized via the location so that the stored location can be recognized when this energy supply device 16 is used again. The supply cable 10, and here, for example, the secondary connector 15 and/or the primary connector 14 and/or the supply line 13, can, for example, be designed (e.g., in that, in addition to the location sensor 18, the memory 19 is also provided in the supply cable 10, e.g., in the secondary connector 15), when a location at which a limit value 200 is stored linked is reached, to transfer the limit value 200 linked to the location as the maximum value to the limiting unit. Alternatively or additionally, the supply cable 10, e.g., the detection apparatus 4 and/or the secondary connector 15 or the like, can be designed to output the linked limit value 200 as a proposal for setting as the maximum value 100. For example, the detection apparatus 4 can be configured or designed in such a way that the link just shown is carried out or performed in it. The location sensor 18 and the memory 19 can then, for example, be arranged or provided in the detection apparatus 4, wherein the location sensor 18 and the memory 19 can also be provided at different locations or on or in different components in the secondary connector 15. The user of the supply cable 10 can thus access already carried-out ascertainments of the limit value 200. The risk of tripping the fuse of the energy supply device 16 during repeated use of the energy supply device 16 is thus advantageously minimized.

FIGS. 4A and 4B show two possible exemplary embodiments for the secondary connector 15.

In FIG. 4A, the setting apparatus 7 is designed as a rotary control or rotary knob. By means of this rotary control, a continuous setting of the maximum value 100 can, for example, be brought about, i.e., a stepless setting. In this case, the term “stepless” is in particular understood to mean that a grading that is unavoidable in digital signal processing is at most 0.2 A. Alternatively, it is also possible for different latching stages or latching positions to be provided so that only a fixedly defined plurality of maximum values 100 can be set, for example separated from one another by latching steps. For example, 1 A, 2 A, 4 A, 6 A, 8 A, 10 A and 13 A can be fixedly predefined as maximum value stages. The user can thus select the maximum value simply and cost-effectively from predefined values. In this case, the maximum value is set quickly and intuitively. By means of the setting apparatus 7, the maximum value 100 for the limiting unit 3 can be set, in particular independently of the detection apparatus 4.

In FIG. 4B, the setting apparatus 7 is designed, by way of example, as a sliding control. Here, too, as in FIG. 4A, a continuous setting of the maximum value 100 is just as possible as a stepped setting to fixedly defined maximum values 100.

Preferably, as shown in FIGS. 4A and 4B, the secondary connector 15 also has a release unit 20, which is designed to release the settability of the maximum value 100 via the setting apparatus 7. The release unit 20 can, for example, be a locking slider and/or a mechanical or electronic lock and/or a fingerprint sensor. It is thus avoided that an adjustment of the maximum value takes place unintentionally. Prior to setting the maximum value 100, the release is thus to be performed via the release unit 20, wherein, in the case of the use of a locking slider, this is in particular merely a protection against unintentionally adjusting, e.g., by unintentionally touching, the setting apparatus. If, on the other hand, a mechanical and/or electronic lock and/or a fingerprint sensor is used, a protection against unauthorized manipulation is also enabled.

The release by the release unit 20 can in particular be indicated visually and/or acoustically. It is also advantageously possible for the limiting unit 3 to allow no current flow through the secondary connector 15 and/or the supply cable 10 during the release for setting the maximum value 100.

The release by the release unit 20 can take place mechanically so that the setting apparatus 7 is mechanically blocked without release. Alternatively or additionally, the release can also take place electronically so that accepting new maximum values 100 takes place only if this is released by the release unit 20, even though the setting apparatus 7 can still be operated.

FIG. 5 schematically shows a further embodiment of the secondary connector 15. The latter has a touchscreen as the setting apparatus 7, wherein a keypad can likewise also be used as the setting apparatus 7.

A memory 19 (cf. FIG. 2), which serves to store different maximum values 100, is advantageously provided. This is in particular advantageous if the setting apparatus 7 does not have a slider and/or a rotary knob as described above. By storing different maximum values, the user can select their own favorite values simply and cost-effectively, for example if the supply cable 10 is repeatedly used at the same energy supply devices 16 with different current supply capacity or fuse. The values stored in the memory 19 can in particular be selected and set as the maximum value 100 via the touchscreen or the keypad as the setting apparatus 7.

As shown in FIG. 5, the secondary connector 15 advantageously has an output unit 17, which can also be present in the embodiments shown in FIG. 4A and FIG. 4B. The output unit 17 serves to output a signal when the detection apparatus 4 has detected said interruption 400. In addition, the output unit 17 advantageously serves to output a signal that the maximum value 100 set by the limiting unit 3 is lower than a maximally possible current-carrying capacity of the secondary connector 15 and/or of the supply cable 10. The signal can, for example, be output directly acoustically and/or visually. Alternatively, a user terminal via which said signals can be output to the user can also be coupled to the secondary connector 15.

Particularly advantageously, a communication module 8 for wireless and/or wired communication with a user terminal is provided. In particular, the maximum current 100 can be set via the user terminal. The communication module 8 can advantageously also serve, as described above, to output signals via the user terminal.

The secondary connector 15 is advantageously designed, for example via the output unit 17 and/or the communication module 8 and/or via a display (see FIG. 5), which may be part of a touchscreen or may be formed separately, to indicate the factor by which the charging time is prolonged through the limitation of the current flow. In particular, the secondary connector 15 is designed to indicate how long the charging of a certain amount of energy, e.g., 10 kWh, is expected to take in the case of the selected limitation (see FIG. 5: here, 5 hours and 14 minutes are indicated by way of example). In this way, a user can adjust the maximum current in a targeted manner to the available charging time (e.g., from 8 pm to 6 am).

The figures do not show an optionally possible reset switch or a reset apparatus. With the latter, for example by a single operating process, the maximum value 100 can be set directly to a (technically) maximally possible maximum value 100 without having to perform further setting processes. This (technically) maximally possible maximum value can, for example, be 13 A in the case of a Schuko secondary connector 15.

It is understood that the secondary connector 15 is preferably designed as an element that can be detached or decoupled from the connecting line 13, in the manner of an adapter. It can nevertheless be provided that the secondary connector is connected fixedly, i.e., not non-destructively detachably, to the connecting line 13 and/or to the supply cable 10.

1-15. (canceled)

16. A supply cable for electrically connecting an energy store of a vehicle to an energy supply device providing electrical energy, the supply cable comprising:
a connecting line;
a primary connector which is or can be electrically coupled to the connecting line and has a vehicle connection configured to releasably electrically connect to the energy store of the vehicle;
a secondary connector which is or can be electrically coupled to the connecting line and is configured to releasably electrically connect to the energy supply device;
a detection apparatus configured to monitor electrical current supplied by the energy supply device and to detect an interruption of the supplied electrical current;
a limiting unit configured to limit an electrical current flowing through the supply cable to a maximum value;
wherein the detection apparatus is configured to: (i) transfer a limit value based on a current supplied prior to the detection of the interruption, as a maximum value to the limiting unit, and/or (ii) output the limit value as a signal value as a proposal for setting as the maximum value.

17. The supply cable according to claim 16, wherein the detection apparatus is configured to detect the interruption when the supplied electrical current is reduced by more than 90% in a time interval of less than one second.

18. The supply cable according to claim 16, wherein the detection apparatus is configured to detect the interruption when the supplied electrical current is reduced by more than 90% in a time interval of less than 100 ms.

20. The supply cable according to claim 16, wherein the detection apparatus is configured to detect the interruption when the supplied electrical current is reduced by more than 90% in a time interval of less than one second, when a comparison of the reduction in the electrical current with a planned reduction in the electrical current exceeds a limit value.

21. The supply cable according to claim 16, wherein the detection apparatus is configured to to ascertain the limit value:
(i) as a function of a last current value detected prior to the interruption, or
(ii) as a function of a mean value of a plurality of detected current values in a predefined time window prior to the interruption, or
(iii) by applying a filtering to a plurality of detected current values prior to the interruption; and
wherein the detection apparatus is in configured to additionally take into account a safety margin for the limit value, the safety margin being at least 5% of the ascertained limit value or which is at least 0.5 A.

22. The supply cable according to claim 16, wherein:
the supply cable can be switched between a learning mode and a normal mode, and wherein: (i) the limiting unit is configured to gradually increase the current flowing through the supply cable, according to a predefined rule up to the maximum value in the learning mode, and to limit the current flowing through the supply cable to the maximum value in normal mode, and/or (ii) the detection apparatus is configured to carry out monitoring of the electrical current supplied by the energy supply device, at a higher monitoring rate in learning mode than in normal mode.

23. The supply cable according to claim 22, wherein the predefined rule includes a predefined ramp for increasing the current.

24. The supply cable according to claim 16, wherein the detection apparatus has a location sensor configured to store a link between the limit value and a location at which the limit value was ascertained, and wherein the detection apparatus is configured, when a location at which a limit value is stored linked is reached, to: (i) transfer the limit value linked to the location as the maximum value to the limiting unit and/or (ii) output the limit value as a proposal for setting as the maximum value to a user.

25. The supply cable according to claim 16, wherein the limiting unit is configured to output the maximum value: (i) to the vehicle and/or (ii) to a charging control logic of the supply cable or of the energy supply device, in order to notify the vehicle that the maximum value can at most be requested as a charging current.

26. The supply cable according to claim 16, wherein the supply cable has an output unit, wherein the output unit is configured: (i) to output an acoustic and/or visual warning, when the detection apparatus detects the interruption, and/or (ii) to output a signal that the maximum value set by the limiting unit is lower than a technically maximally possible maximum value.

27. The supply cable according to claim 16, wherein the supply cable has a setting apparatus, via which the maximum value can be set by a user, wherein the setting apparatus has a rotary knob or a slider or a touchscreen or a keypad, for setting the maximum value.

28. The supply cable according to claim 27, wherein the maximum value can be selected from a plurality of predefined values via the setting apparatus, or the maximum value can be set steplessly from a predefined interval via the setting apparatus.

29. The supply cable according to claim 27, wherein the supply cable has a memory, which is configured to store different maximum values by a user.

30. The supply cable according to claim 27, wherein the supply cable has a communication module for communication with a user terminal in order to set the maximum value via the user terminal, wherein the communication module is configured for wireless communication with the user terminal.

31. The supply cable according to claim 27, wherein the supply cable has a release unit which is configured to release a settability of the maximum value via the setting apparatus, wherein the release unit has: (i) a locking slider and/or (ii) a mechanical or electronic lock and/or (iii) a fingerprint sensor.

32. The supply cable according to claim 27, wherein the supply cable has a reset function, wherein, when the reset function is activated, a technically maximally possible maximum value is set, and wherein the reset function: (i) can be activated by a user, and/or (ii) is activated when the supply cable is decoupled from the energy supply device.

33. The supply cable according to claim 16, wherein the connecting line has a coupling, which is configured to be detachably electrically connected to the secondary connector.
